(19) United States
(12) Patent Application Publication
(10) Pub. No.: US 2004/0045002 A1
(43) Pub. Date: Mar. 4, 2004

(54) Method system and apparatus for multiprocessing

(76) Inventors: Ricardo Berger, Kadima (IL); Yoram Yeivin, Hod Hasharon (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/398,612

(22) PCT Filed: Oct. 5, 2001
(86) PCT No.: PCT/IL01/00930

(51) Int. Cl. G06F 13/00

(52) U.S. Cl. 718/102; 710/111

(57) ABSTRACT

A multi-processing method, system and apparatus having a processor, a request order key issuer connected to the processor which may issue an request order key to a task to be performed by the processor. A resource access order provider may be connected to the processor and may issue access order values to a task in relation to the task's request order key.

### FIELD OF THE INVENTION

The present invention relates generally to the field of parallel and/or multi-processing. More specifically, the present invention relates to a method, system and apparatus for parameter coherency keeping, ordered execution and priority assignments of tasks executed in a multiprocessor and/or multithreading system.

### BACKGROUND OF THE INVENTION

When there is a need to implement a multiprocessor or a multistage processor system to handle a high performance application such as a real time packet or cell handling system in a communications link, two architecture strategies are known, pipelining and striping.

Using pipelining, a task to be performed or implemented is divided in subtasks. As shown in FIG. 1, each sub-task is assigned to a different processor in an array of processors which may be connected in series. Each processor is responsible for handling or processing its assigned subtask. However, since the processors are in series, each processor unit takes the output (result) of a previous processor, adds a new level of processing, and generates a result that is passed along to and handled by a subsequent processor or processing unit. A disadvantage of a pipelining system is that since there is only one processing path, poor performance in any one of the processors may create a bottleneck for the rest. Therefore, the slowest processor unit determines the total performance or throughput of a pipelining multiprocessor system.

In striping, each on of the processors in the system handles a whole task for an input event. As shown in FIG. 2, consecutive events are distributed to different processors. The number of processors (N) in such a system may be calculated taking into consideration the maximum time that takes to each one of the processors to handle a single event. If T is the total time needed to handle an event by one single processor, and F is the frequency of the events, then the number of processors N may be calculated to be N=T×F.

A disadvantage of the Striping architecture (compared with the pipeline one) resides in the fact that under variations of the time execution in the software that handles a single event (packet), no completion order is guaranteed. Assume that the maximum execution time to handle an event is E_{MAX}; and the minimum execution time to handle an event is E_{MIN}. Assume that the arrival time for the event i is Tᵢ and the arrival time for event i+1 is Tᵢ₊₁. If T₁+E_{MAX}≧Tᵢ₊₁+E_{MIN}, then, the processor that handles the event i+1 will finish its task before the processor that handles the event i. The same conclusion is valid for a partial stage in the total execution of the task: If some partial stage is to be concluded according to the order of the input events, the striping architecture does not support it “naturally”.

An additional point that is to be handled properly is the access to global parameters by tasks handled in different processors. This issue relates to the parameter coherency (i.e. every packet has to update a variable according to the order of arrival and its data contents).

### SUMMERY OF THE INVENTION

As part of the present invention, there may be a multi-processing apparatus having at least one processor, a request order key issuer connected to the processor such that the issuer may issue a request order key to one or more tasks to be performed by the processor. A resource access order provider may issue a resource access value to a task in accordance with a request order key provided by the processor.

### BRI F DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram showing a pipeline type computing architecture of the prior art;

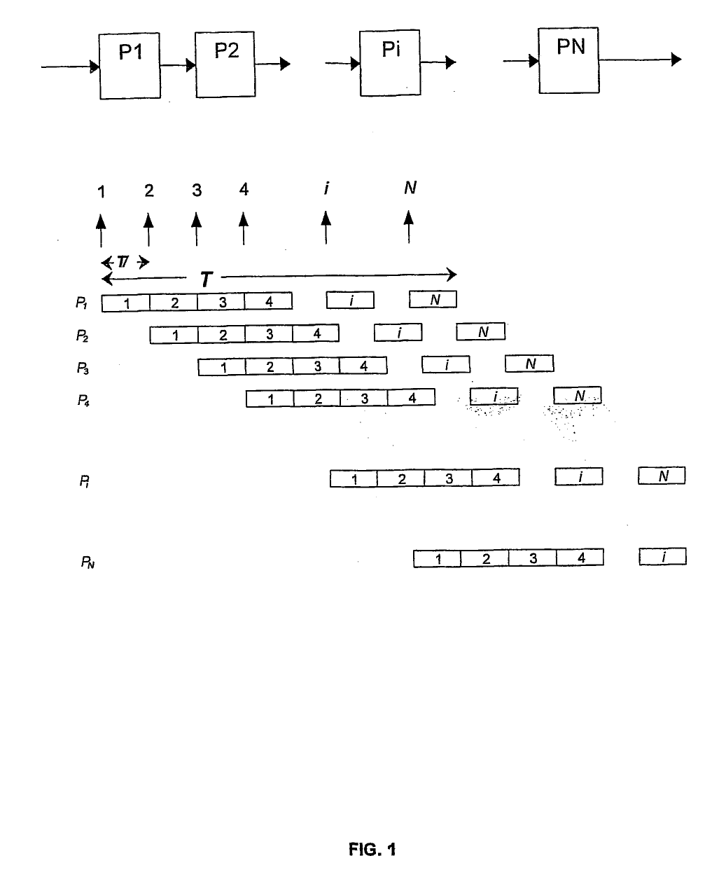

FIG. 2 is a block diagram showing a striping type computing architecture of the prior art;

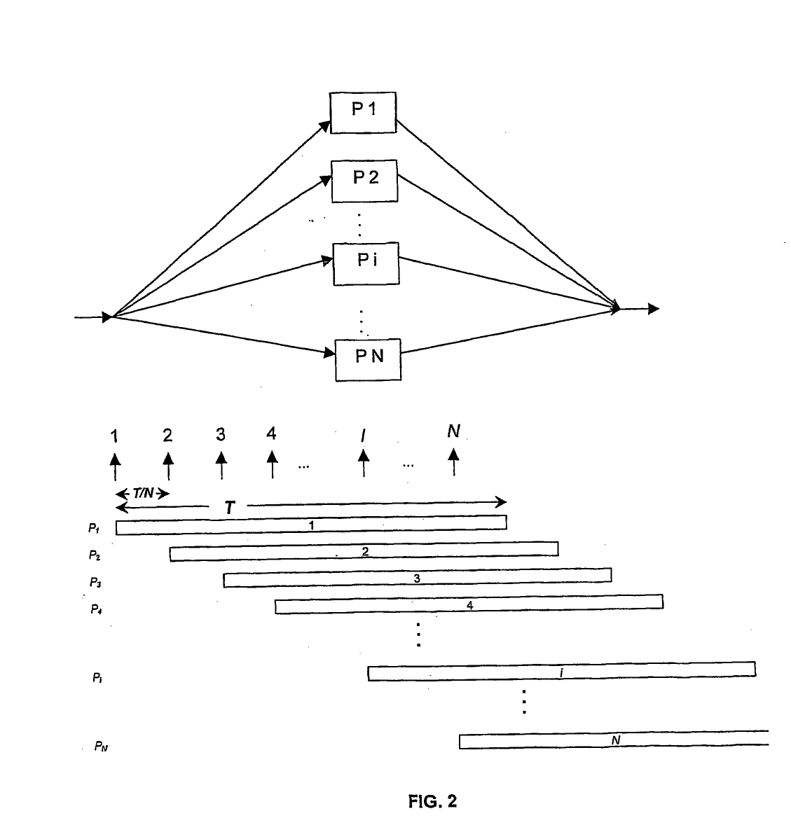

FIG. 3 is a block diagram showing an example of a multiprocessing system according to the present invention;

FIG. 4 is a diagram showing a mechanism by which a request order values may be provided according to the present invention; and

FIG. 5 is a diagram showing a mechanism by which ordered access to a resource may be enforced.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

As part of the present invention, there may be a multi-processing apparatus having at least one processor, a request order key issuer connected to the processor such that the issuer may issue an order key to one or more tasks to be performed by the processor. A resource access order provider may be connected to the processor 1o and may issue a resource access value to a task upon request of the processor. A resource Gatekeeper maybe connected to the processor and may provide the processor access to the resource access order provider in accordance with a request order key submitted by the processor.

Multiple tasks may each be run on multiple threads on a single processor, or each may be on a different processor. Each thread or processor may request one or more resource access order values for a task it is processing, and each order value for a specific resource may be issued in accordance with the sequence of the request order keys assigned to the tasks. The resource access order provider may not issue an access order value to a task or process until all the tasks or processes with earlier request order keys have requested resource access order values. In an embodiment of the present invention, a process requiring a resource access value must first request from the resource gatekeeper permission to access the resource access order provider.

Each task may access a resource for which it has received a resource access value after tasks with lower resource access values have already accessed the resource. If a task attempts to access a resource prior to another task with a lower or earlier resource access value, the request of the first task may be placed in a buffer, which buffer may be checked at a later time, for example, after another task has accessed the resource. A task whose request for a resource has been placed in a buffer may be suspended until access to the resource is available.

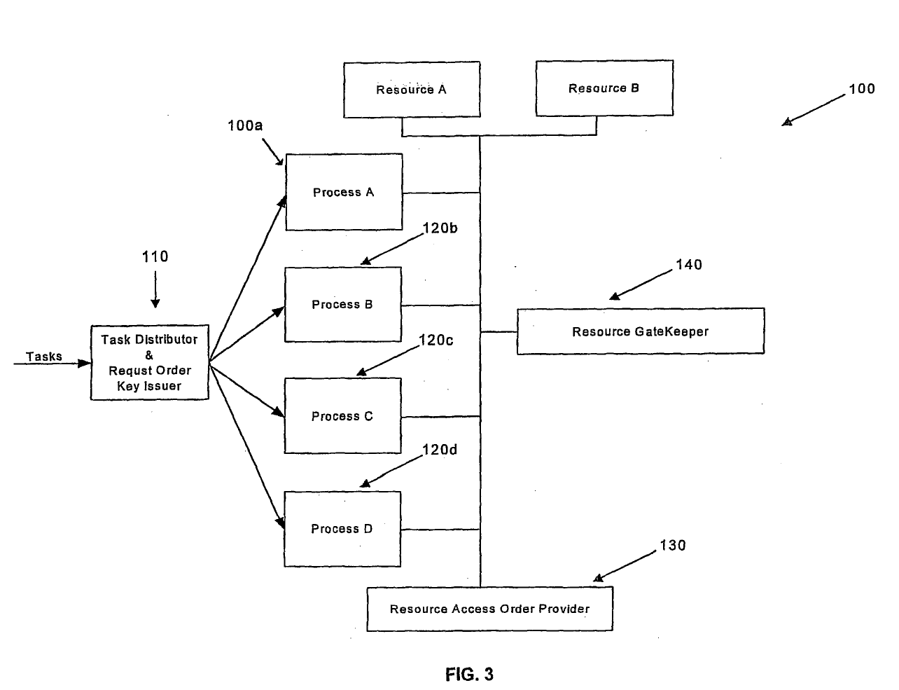

Turning now to FIG. 3, there is shown an example of a multiprocessing system 100 according to the present invention. The system 100 may receive tasks to be performed through a communications port. The received tasks may include computations to be performed for applications such as voice or video processing, or may be data packets requiring processing and/or routing. The nature of the task to be performed is not relevant and the system 100 may be used for any application for which multiprocessing may be beneficial.

Once a task is received by the system 100, it may be assigned a request order key and may be distributed to one of the processes A through D by a Task Distributor and Request Order Key Issuer 110. Key issuing and task distribution may be performed by a single unit 110 or may be performed by two or more separate is units. For example, a communications port may be adapted to issue request order keys to data packets being received over the port. The request order keys issued to each task may be sequentially marked, such that each successive task is issued a request order key with a successively incremented value from the previous key. The request order key may also be referred to as a master key.

A task with an assigned request order key may be distributed or sent to one of the Processes A through D, 120a-120d. The processes 120a-120d may run on a signal processor, e.g. a processor running a multi-threading operating system, or on multiple processors where each processor may have also multiple processes running thereon. Determination as to which processor to distribute a task may take into consideration the processing load on each of the processors 120a-120d (i.e. load balancing the processors), or may simply be done in a random or round-robin fashion.

Once a task is assigned to a processor and a process begins for the task, the process may determine whether to break up or partition the task into sub-tasks which may be processed by separate sub-processes. The processor which receives a task may also analyze the task to determine what resources the task may require for completion of its processing. Resources which a process working on a task may require may include memory registers, system variables or parameters which may need to be accessed and/or modified, common sub-processes which may need to be performed, access to communications ports, etc.

A process may pass to resource access order provider 130 a request order key assigned to a task it is processing. Along with the request order key, also known as the task's master key, the process may pass to the resource access order provider 130 a list of the resources and/or sub-processes to which the process requires access. Collectively, the master key along with the list of required resources may be referred to as a Tag. The resource access order provider 130 may maintain an access order list for each resource and sub-task in the system 100, and may provide a process which has submitted a tag with a resource access value for one or more of the resources listed within the tag.

In an embodiment of the present invention, a process may first pass its request order key to the resource gatekeeper 140, thereby requesting access to the resource access order provider 130. Once the gatekeeper 140 grants the application access to the resource access order provider 130, the process may only need to pass to the resource access order provider 130 a list of resources to which it requires access. In this embodiment the Tag only needs to contain the list of required resources and an identifier of the process submitting the Tag. The identifier may contain information about the processor and the thread to which the process belongs. As part of this embodiment, the resource access order provider 130 may be treated by the gat keeper 140 as just another resource of the system 100.

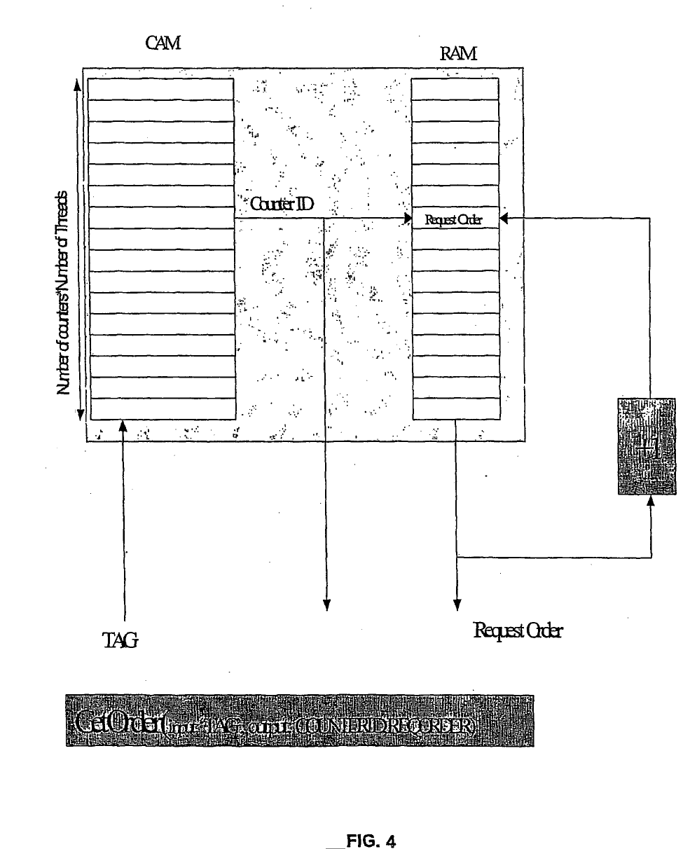

Turning now to FIG. 4, there is shown an example of a possible embodiment of a resource access order provider 130 according to the present invention. As part of the resource access provider 130, a Contents Addressable Memory (“CAM” may store a CounterID identifying a set of counters associated with each system resource to which a process may request access. Each resource may have an associated set of counters, a request counter and a service counter. Each resource's pair of associated counters may be designated by a unique label, namely a CounterID.

As a tag is received by the resource access order provider 130, the CAM is checked to determine a CounterID for each of the resources listed within the tag. Once a CounterID is determined for a given resource the resource access order provider 130 may check the current value of the CounterID's request counter. A CounterID and its request counter's current value may be provided to a process in response to the process submitting a tag to the resource access order provider 130. The request counter's current value for a given CounterID or resource, which is provided to a process submitting a tag, may be referred to as a resource access value for the given resource. The combination of a CounterID and its associated resource access value, which is provided to a process in response to the process submitting a tag, may be referred to as a resource key. In response to a process submitting a tag with more than one resource listed therein, the resource access order provider 130 may provide the process with a resource key for each of the resources listed in the tag. Once a CounterID and its request counter's current value are provided to a resource, the CounterID's request counter may be incremented by some value, for example by 1.

Once a process has received from the resource access order provider 130 a resource key for a resource which the process may require for the processing of the task it has been assigned, the process may proceed with the processing of its assigned task. Before the process may access the resource for which it received a resource key, the process must submit the resource key for the given resource to a resource gatekeeper 140. The resource gatekeeper 140 may compare the resource access value of the submitted resource key against the current value of the service counter corresponding to the CounterID of the resource key. If the resource access value in the submitted resource key matches the value of the service counter, the gatekeeper grants the process permission to access the resource and the service counter is incremented. Each time permission to access a resource is granted, the associated service counter is incremented.

If however, a submitted resource key's resource access value does not match the current value of the relevant service counter, permission is not granted to the process and the resource key, along with information identifying the process which submitted the key, are stored in a Service Pending CAM. Once the submission of a subsequent resource key causes the service counter to be incremented, a check Service Pending CAM function is executed. If there is found a resource key whose resource access value matches the service counter value, the process associated with the key is granted access to the resource associated with the given key and service counter.

In order to get specific resource access values, the process initiates an access to the resource access order provider by submitting a tag with the resources listed therein.

However, a process requesting one or more resource access values, for example by submitting a tag with the resources listed therein, may not be granted any resource access values until all the processes processing tasks having a lower request order key values have received their resource access values. That is, a process working on a task may receive a resource access value or resource key for a resource the task requires in the same relative order the task arrived at the syst m 100. The resource access provider 130 may allow only one process to receive a resource access value at a time, and may keep track of the request order keys for which it has provided resource access values. Hence the resource access provider 130 may deny resource access values to a process presenting a tag with a request order key which is not sequentially higher than the previous tag for which the request order provided 130 granted resource access values. For example, if the request order provider 130 grants resource access values to a process with a request order key having a marked value of 0002, the next process which may receive a resource access value must submit a request order key having a marked value of 0003, assuming a sequential interval of one for each successive key. The sequential interval or increment between the values of sequential request order keys may, however, be defined as being greater than one or may be a negative value.

In one embodiment of the present invention, access to the resource access order provider 130 is regulated by the resource gatekeeper 140. Therefore, in that embodiment, it is the gatekeeper 140 which enforces the order by which processes may obtain resource access values from the resource access order provider 130. It is the gatekeeper 140 which checks whether a request order key submitted by a process is sequentially higher than the previous request order key for which the request order provided 130 granted resource access values. It is the gatekeeper 140 which may grant or deny access to the resource access order provider 130.

As mentioned above, resources for which a resource key may be required may include system variables or parameters, sub-processes or sub-tasks, and access to communication ports. The resource for which a resource key is required may be a sub-process or sub-task such as data output for example. By requiring a resource key for such a subtask, order of execution or tasks may be enforced.

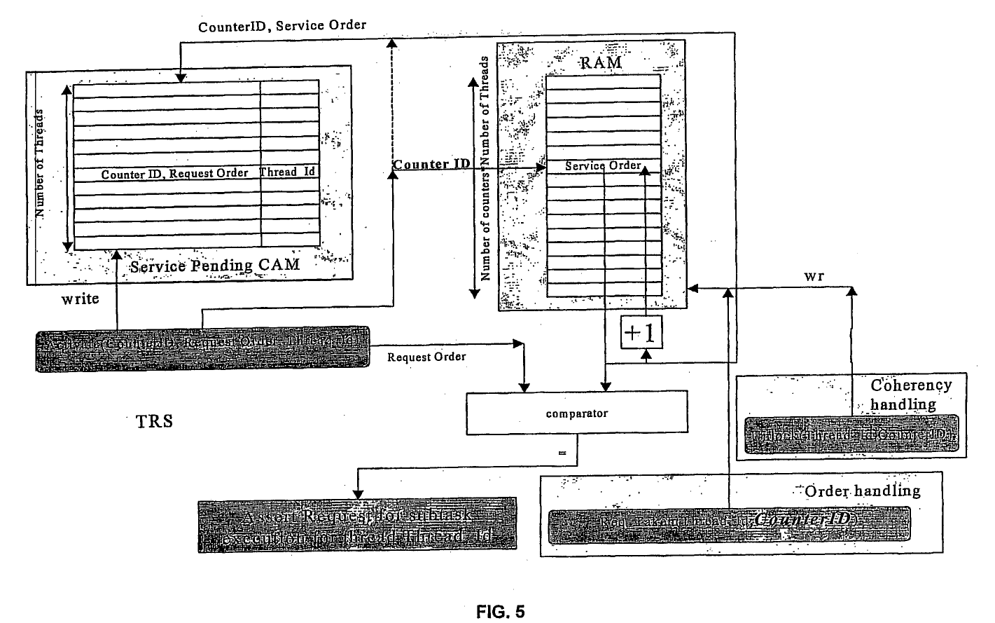

An embodiment of a resource gatekeeper 140 according to the present invention is shown in FIG. 5. When a subtask that has to keep order or parameter coherency execution is initiated, it may send an Activate indication to the gatekeeper. In the 1^{st} step, the Request Order (resource key) for this event is compared with the Service Order counter value for the appropriate CounterId. If it matches, the subtask is allowed to continue execution. If it is not allowed to execute, it means that a subtask that has a lower Request Order (resource access value) for the same CounterId has not started its run (or did not finish its execution if parameter coherency is required for this subtask). In this case, the information for the current event, including CounterId, Request Order and Thread_Id are stored in a free location of the Service Pending CAM.

In the case of ordered execution, when the subtask starts to run (or is forwarded to a machine to run) an indication Req_Taken is sent to the resource gatekeeper in order to allow it to increment the Service Order Counter for the specific CounterId. After doing that, a compare action is initiated in the Service Pending CAM with the CounterId and the new value of the Service Order Counter in order to check if there is a pending request for the same CounterId that could not be executed at its request time because of an unmatched compare. If a match is found, a new request for subtask execution is sent for the corresponding thread stored in the CAM entry.

In the case of a parameter coherency type of subtask, when the subtask finishes its execution, an indication Unlock is sent to the mechanism by the subtask in order to allow the increment of the Service Order Counter for the specific CounterId.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A method of processing multiple tasks comprising assigning to at least one of the tasks a request order key.

2. The method according to claim 1, further comprising submitting a request order key to a resource access order provider.

3. The method according to claim 2, further comprising accessing a resource in accordance with a resource access value provided by the resource access order provider.

4. The method according to claim 2, further comprising providing a resource access value for each of at least two resource.

5. The method according to claim 4, further comprising accessing more than one resource in accordance with each resource's resource access value.

6. The method according to claim 5, wherein one of the resources is a memory register and another of the resources is a computational process.

7. The method according to claim 4, further comprising assigning a resource access value in the same order as a value associated with the submitted request order key.

8. A multi-processing apparatus comprising a processor, a request order key issuer operatively connected to said processor and adapted to issue a request order key to a task to be performed by said processor, and a resource access order provider operatively connected to said processor and adapted to issue a resource access value in accordance with a request order key.

9. The apparatus according to claim 8, further comprising a second processor adapted to submit a task's request order key to said resource access order provider.

10. The apparatus according to claim 8, wherein said processor is adapted to run multiple threads.

11. The apparatus according to claim 8, further comprising a resource gatekeeper.

12. The apparatus according to claim 11, wherein said processor may not access a resource for a given task until the task's access order value for the resource match's a service counter value related to the resource.

13. The apparatus according to claim 12, wherein said resource access order provider is adapted to issue a resource access order value to a task in accordance with the task's request order key.

14. The apparatus according to claim 13, wherein said resource access order provider will not issue to a task a resource access order value for a resource until a task with an earlier request ord r key submits its key.

15. A system for multiprocessing comprising:
a multiprocessor having a request order key issuer operatively connected to a processor and adapted to issue an order key to a task to be performed by said processor, and a resource access order provider operatively connected to said processor and adapted to issue a resource access value in accordance with a request order key; and
a serial port operatively connected to said processor.

16. A system according to claim 15, further comprising a data buffer lo operatively connected to said serial port.

17. The system according to claim 15, further comprising a second processor adapted to submit a task's request order key to said resource access order provider.

18. The system according to claim 15, wherein said processor is adapted to run multiple threads.

19. The system according to claim 15, further comprising a resource gatekeeper.
